(19) United States
(12) Patent Application Publication
(10) Pub. No.: US 2017/0054187 A1
(43) Pub. Date: Feb. 23, 2017

(54) BATTERY HEATER CONTROLLERS AND INFRASTRUCTURE CABINETS INCLUDING BATTERY HEATER CONTROLLERS

(71) Applicant: Emerson Network Power, Energy Systems, North America, Inc., Warrenville, IL (US)

(72) Inventors: Michael M. KRZYWOSZ, Lisle, IL (US); Matthew Alan PHILIPPS, North Ridgeville, OH (US)

(21) Appl. No.: 14/870,902

(22) Filed: Sep. 30, 2015

Related U.S. Application Data
(60) Provisional application No. 62/206,509, filed on Aug. 18, 2015.

(51) Int. Cl. H01M 10/635; H01M 10/615; H02M 7/06; H01M 10/6571; H01M 10/48; H01M 2/10; H01M 10/12; H01M 10/627

(52) U.S. Cl. CPC H01M 10/635; H01M 10/121; H01M 10/615; H01M 10/627; H01M 10/6571; H01M 10/486; H01M 10/488; H01M 2/1072; H02M 7/06; H01M 2220/10

(57) ABSTRACT

Battery heater controllers and infrastructure cabinets including battery heater controllers are disclosed. Example battery heater controllers may include an input terminal for receiving an AC input voltage, an output terminal for providing an AC output voltage to a battery heater, a thermistor for sensing an ambient temperature, and an electronic relay coupled between the input terminal and the output terminal to selectively interrupt the AC output voltage provided to the battery heater based on the ambient temperature sensed by the thermistor. Example infrastructure cabinets and methods are also disclosed.

### CROSS-REFERENCE TO RELATED APPLICATION

This application claims the benefit of U.S. Provisional Patent Application No. 62/206,509 filed Aug. 18, 2015. The entire disclosure of the above application is incorporated herein by reference.

### FIELD

The present disclosure relates to battery heater controllers and cabinets infrastructure including battery heater controllers.

### BACKGROUND

This section provides background information related to the present disclosure which is not necessarily prior art.

Infrastructure cabinets (e.g., outside plant telecommunication cabinets, electric utility outdoor relaying cabinets, railroad outdoor gate control cabinets, etc.) commonly employ energy storage batteries (e.g., lead-acid batteries, etc.) for back-up autonomy in the case of an AC power outage. Battery compartments within the cabinet are typically not sealed due to hydrogen gas safety, and may not be climate controlled. The compartments may, however, use local heating devices to warm up the batteries in the cold (e.g., winter) months.

Batteries typically have lower energy capacities at temperatures less than room temperature (e.g., less than 25 degrees Celsius). Accordingly, it may be desirable to heat up and maintain battery temperatures near room temperature (or any other suitable temperature) to capture the battery's full rated power and energy capacity.

Battery heaters can include heater plates, space heating elements, etc. These types of battery heaters may require a control circuit to control the power provided to the battery heaters. For example, a control circuit may be used to turn on and turn off power provided to the heaters, so that the heaters are used as needed to warm the batteries.

AC electric heaters can be used in a “hot plate” style to warm lead-acid batteries from a low ambient temperature to near room temperature to capture the battery's full rated energy capacity. Example battery heaters include commercial AC powered (typically 120VAC) resistance wire heaters, graphite silkscreen heaters, etc.

### SUMMARY

This section provides a general summary of the disclosure, and is not a comprehensive disclosure of its full scope or all of its features.

According to one aspect of the present disclosure, a battery heater controller includes an input terminal for receiving an AC input voltage, an output terminal for providing an AC output voltage to a battery heater, a thermistor for sensing an ambient temperature, and an electronic relay coupled between the input terminal and the output terminal to selectively interrupt the AC output voltage based on the ambient temperature sensed by the thermistor.

According to another aspect of the present disclosure, a battery heater system includes a battery, a battery heater adjacent the battery to warm the battery, and a controller. The controller includes an input terminal, an output terminal coupled to the battery heater, a temperature sensor, and an electronic relay coupled between the input terminal and the output terminal to selectively interrupt AC power provided to the battery heater at the output terminal based on an ambient temperature sensed by the temperature sensor.

According to another aspect of the present disclosure, a method of controlling a battery heater to warm a battery is disclosed. The battery heater is adjacent the battery in a cabinet. The method includes receiving an AC input voltage at an input terminal, sensing an ambient temperature via a temperature sensor, and switching an electronic relay coupled between the input terminal and the battery heater based on the sensed ambient temperature to selectively interrupt AC power provided to the battery heater.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a block diagram of an example cabinet and battery heater controller according to one embodiment of the present disclosure.

FIG. 2 is an example circuit diagram of the battery controller of FIG. 1.

FIG. 3 is a top view of an example battery heater controller mounted on a printed circuit board, according to another embodiment of the present disclosure.

FIG. 4 is a top view of the PCB of FIG. 3, illustrating a wiring layout.

FIG. 5A is a perspective view of an example enclosure for a battery heater controller according to another embodiment of the present disclosure.

FIG. 5B is a front view of the enclosure of FIG. 5A.

FIG. 5C is a perspective view of an example cover plate of the enclosure of FIG. 5A.

FIG. 5D is a front view of the cover plate of FIG. 5C.

FIG. 6 is a schematic of a battery heater controller according to another example embodiment of the present disclosure.

Corresponding reference numerals indicate corresponding features throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

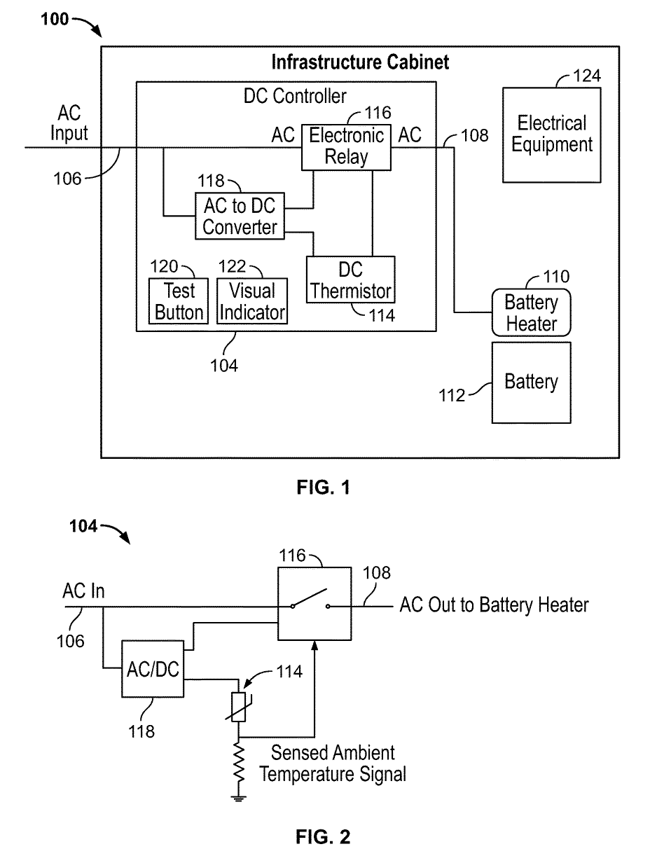

An infrastructure cabinet according to one example embodiment of the present disclosure is illustrated in FIG. 1 and indicated generally by reference number 100. As shown in FIG. 1, the infrastructure cabinet 100 includes a controller 104. The controller 104 includes an input terminal 106 for receiving an AC input voltage, an output terminal 108 for providing an output AC voltage to a battery heater 110, a thermistor 114 for sensing an ambient temperature, and an electronic relay 116 coupled between the input terminal and the output terminal to selectively interrupt the AC output voltage provided to the battery heater based on the ambient temperature sensed by the thermistor 114.

The infrastructure cabinet 100 is an outside plant (OSP) telecommunication cabinet, but other suitable infrastructure cabinets could be used in other embodiments, such as electric utility relaying cabinets, railroad gate control cabinets, etc.

The infrastructure cabinet 100 includes a battery 112. The battery heater 110 is positioned adjacent the battery 112 to warm the battery. The battery 112 can be any suitable battery, including a lead-acid battery (e.g., valve-regulated lead-acid battery), etc. The battery 112 may be a back-up battery that provides power to electrical equipment 124 in the infrastructure cabinet 100 (as shown in FIG. 1), other electrical equipment outside the infrastructure cabinet 100 (not shown), etc. For example, power may be provided to the electrical equipment 124 from battery 112 in the event of a loss of utility power (e.g., AC utility input power) at input terminal 106. In some embodiments, the battery 112 may be used to power electrical equipment 124 in non-back-up power conditions.

Although only one battery 112 is illustrated in FIG. 1, other example embodiments may include multiple batteries of the same or different type. The battery 112 may be located in the cabinet interior, such as in a battery compartment of the cabinet 100, etc.

The battery heater 110 can be any suitable battery heater including, for example, a heater plate, a space heating element, a resistance wire heater, a graphite silkscreen heater, etc. The battery heater 110 may be adjacent the battery 112 (e.g., in thermal contact with, in direct contact with, etc.) to provide heat to warm the battery. In some embodiments, the battery 112 may be disposed within a battery compartment inside the cabinet 100 and the battery heater 110 may be disposed within the same battery compartment to warm ambient air around the battery 112. The battery heater 110 is a 120 VAC battery heater, but other suitable voltages could be used in other example embodiments.

Although only one battery heater 110 is illustrated in FIG. 1, other example embodiments may include more battery heaters of the same or different type.

The input terminal 106 of the controller 104 is adapted for receiving an AC input voltage (e.g., 120 VAC, etc.) from any suitable AC source (e.g., an AC utility input, AC power grid, etc.). The input terminal 106 may include an electrical connector, input pin, etc. Although FIG. 1 illustrates only one input terminal 106, other embodiments may include more than one input terminal (e.g., three input terminals for a single phase source, three or more input terminals for a three phase source, multiple input terminals for multiple AC sources, etc.).

The output terminal 108 is coupled to the battery heater 110 to provide an AC output voltage and current to the battery heater. For example, the output terminal 108 may be coupled to the battery heater 110 via one or more electrical wires. The output terminal 108 of FIG. 1 provides a 120 VAC output voltage to the battery heater, but other suitable output voltages may be used in other example embodiments. The output may correspond to a voltage rating of the battery heater 110. Although FIG. 1 illustrates only one output terminal 108, other embodiments may include more than one output terminal (e.g., three output terminals for single phase AC power, three or more output terminals for three phase AC power, multiple output terminals for multiple battery heaters, etc.).

The thermistor 114 (e.g., temperature sensor, etc.) of the controller 104 senses an ambient temperature corresponding to the temperature of the battery 112. For example, the ambient temperature may include a temperature in the infrastructure cabinet 100, such as a temperature of a battery compartment housing the battery 112 (e.g., a temperature adjacent the battery). The thermistor 114 is powered by a DC power source and can include any suitable temperature sensor capable of sensing an ambient temperature in the cabinet (e.g., a negative temperature coefficient thermistor, a positive temperature coefficient thermistor, etc.).

As shown in FIG. 1, the electronic relay 116 is coupled between the AC input 106 and the AC output 108. The electronic relay 116 may be any suitable DC powered relay (such as a switch (e.g., transistor), etc.) capable of selectively interrupting the flow of current between the input terminal 106 and the output terminal 108. For example, the electronic relay 116 may switch on and switch off AC current from the input terminal 106 to the output terminal 108 to control the AC power provided to the battery heater 110 at the output terminal 108, by opening and closing the current path between the input terminal 106 and the output terminal 108. Accordingly, selectively interrupting power to the battery heater 110 may include coupling the input terminal 106 to the output terminal 108 so that AC current flows therebetween by closing a switch, and then decoupling the input terminal 108 from the output terminal 108 to interrupt current flow therebetween by opening the switch.

In the example of FIG. 1, the thermistor 114 is coupled to the electronic relay 116 to provide a signal representing a sensed temperature to the electronic relay. The electronic relay 116 may control the AC current provided at the output terminal 108 based on the sensed temperature from the thermistor 114. When the sensed temperature is below a defined temperature threshold (e.g., a full capacity temperature rating of the battery 112, about room temperature, about 25 degrees Celsius, etc.), the electronic relay 116 may couple (e.g., complete the circuit between) the input terminal 106 and the output terminal 108 to allow AC power to energize the battery heater 110 to warm the battery 112.

As an example, when the sensed temperature is below the defined temperature threshold, the electronic relay 116 may connect the input terminal 106 to the output terminal 108 so that AC power is provided to the battery heater 110 to warm the battery 112. When the sensed temperature is above the defined temperature threshold (e.g., the full capacity temperature rating of the battery 112, etc.) the electronic relay 116 may interrupt (e.g., turn off, etc.) the AC power to the output terminal 108, thereby removing power from the battery heater 110 (e.g., turning off the battery heater, de-energizing the battery heater, etc.). Accordingly, the electronic relay 116 may control (e.g., selectively interrupt) power to the battery heater 110 to maintain the temperature of the battery 112 above a defined temperature threshold, based on the sensed temperature from the thermistor 114.

Additionally, the controller 104 includes an AC to DC converter 118. As shown in FIG. 1, the AC to DC converter 118 is coupled between the input terminal 106 and the thermistor 114 to provide DC power to the thermistor. The AC to DC converter 118 is also coupled between the input terminal 106 and the electronic relay 116 to provide DC power to the electronic relay 116.

The AC to DC converter 118 may include any suitable AC to DC converter topology, including a combination of one or more transformers, one or more rectifiers, etc. capable of converting an AC voltage to a DC voltage. For example, a transformer may convert the AC input voltage to an intermediate AC voltage, and then a rectifier may be used to convert the intermediate AC voltage to a DC voltage suitable for powering the thermistor 114, electronic relay 116, etc. A 120 VAC to 24 VAC transformer may be used to reduce the AC input voltage, and a rectifier may convert the 24 VAC to 24 VDC for powering the DC thermistor 114, electronic relay 116, etc. Other embodiments may convert to other suitable DC voltage values (e.g., 12 VDC, etc.), which may be based on the voltage ratings of the DC thermistor 114, the electronic relay 116, etc. In some embodiments, the AC input may be rectified and then stepped down with a buck converter, etc.

As shown in FIG. 1, the controller 104 includes a visual indicator 122 for indicating proper operation of the controller. The visual indicator 122 can be any suitable visual indicator including, for example, a light emitting diode, a light bulb, any other type of display, etc. The visual indicator 122 may be energized (e.g., activated, turned on, etc.) when the output terminal 108 is providing AC output power to the battery heater 110. Accordingly, the visual indicator 122 may light up during periods in which the battery heater 110 is currently heating the battery 112. In some example embodiments, the visual indicator may not be used.

As shown, the controller 104 includes a test button 120, which may be used to test whether the controller 104 is working properly. Pressing the test button 120 may cause the visual indicator 122 to light up if the controller 104 is capable of providing AC output power at the output terminal 108. For example, during warmer periods the battery heater 110 may not be needed so the visual indicator 122 would normally be off. The test button 120 allows a technician to determine whether the controller 104 is still operating properly even when the battery heater 110 is not in use. In some example embodiments, the test button may not be used.

The controller 104 may include any other suitable indicators (not shown in FIG. 1) including, for example, an indicator signifying that AC input power is present at the input terminal 106, etc.

The controller 104 may include a printed circuit board (PCB). For example, the components of the controller 104 may be mounted on a printed circuit board, with PCB wiring connecting different components. The PCB may have terminal connectors mounted on the PCB for connections to AC inputs and AC outputs. The PCB may be pre-connectorized. In some embodiments, the controller 104 may not include any microprocessor, such that no microchip, software, etc. may be required to operate the electronic controls of the controller 104.

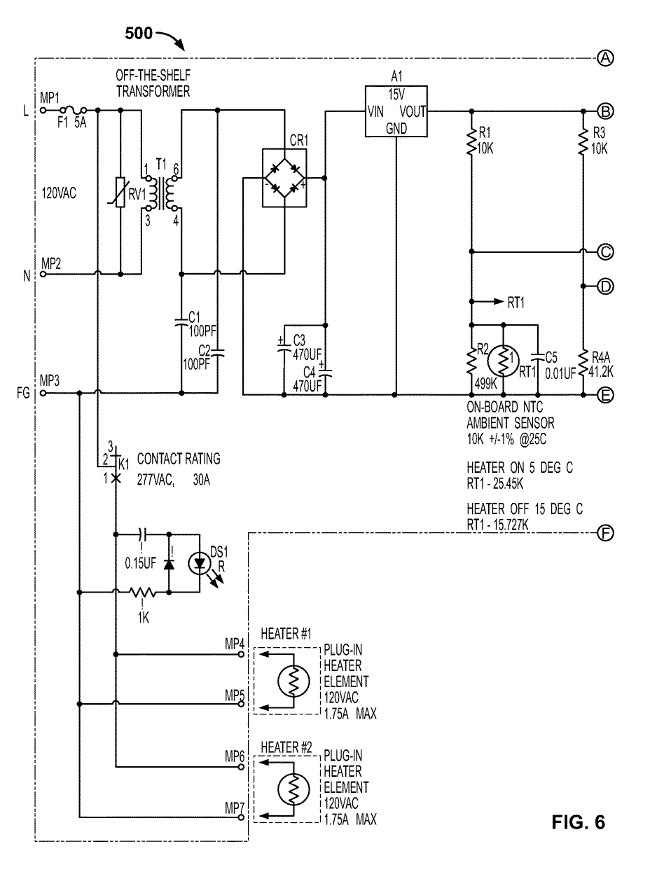

The cabinet 100 may include an enclosure (see, e.g., FIGS. 5A-5D discussed below) that encloses the controller 104 and its components. The enclosure protects the controller 104 from the weather and other outdoor elements, by inhibiting those elements from contacting the controller. In some example embodiments, the enclosure may be weather-tight. The enclosure may be suitable for hardened outdoor use. For example, the enclosure may provide an operational range of about −40 degrees Celsius to about 52 degrees Celsius (or any other suitable range). The enclosure may allow operation up to 100% relative humidity non-condensing.

The test button 120 may be accessible from outside the enclosure, such that a technician does not have to open the enclosure to use the test button 120. Similarly, the visual indicator 122 may be viewable without opening the enclosure.

As explained above, the cabinet 100 includes electrical equipment 124. The electrical equipment 124 may be any suitable electrical equipment including, for example, telecommunication infrastructure equipment, railroad control equipment, electric utility equipment, etc.

In some embodiments, the cabinet 100 may not be climate controlled. For example, the cabinet 100 may not be adapted to maintain an ambient temperature inside the cabinet at a set point temperature (e.g., room temperature). This may cause the temperature inside the cabinet 100 (as well as the battery 112 disposed inside the cabinet) to reduce below the full capacity temperature rating of the battery, such that the battery heater 110 is needed to warm the battery during cold weather. Accordingly, in some embodiments the controller 104 may be used to control a dedicated battery heater 110 for lead-acid batteries in a non-temperature controlled cabinet, and not for warming a conditioned space.

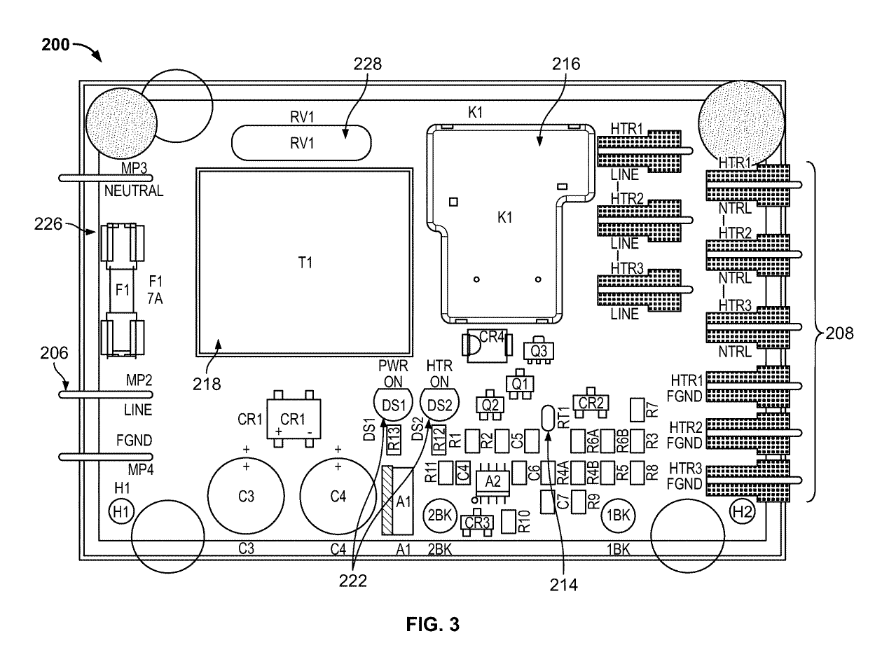

FIG. 2 illustrates an example circuit diagram of the battery heater controller 104 of FIG. 1. As shown, the thermistor 114 is coupled to the electronic relay 116 to provide a sensed ambient temperature signal to the electronic relay. For example, the thermistor 114 changes resistance based on the ambient temperature. The resistance changes of the thermistor 114 adjust the voltage of the sensed ambient temperature signal to the electronic relay 116. Accordingly, the electronic relay 116 can open and close based on the sense ambient temperature signal received from the thermistor 114. The thermistor 114 may be designed, selected, etc. such that the sensed ambient temperature signal exceeds a voltage threshold when the temperature of the thermistor 114 exceeds a temperature threshold.

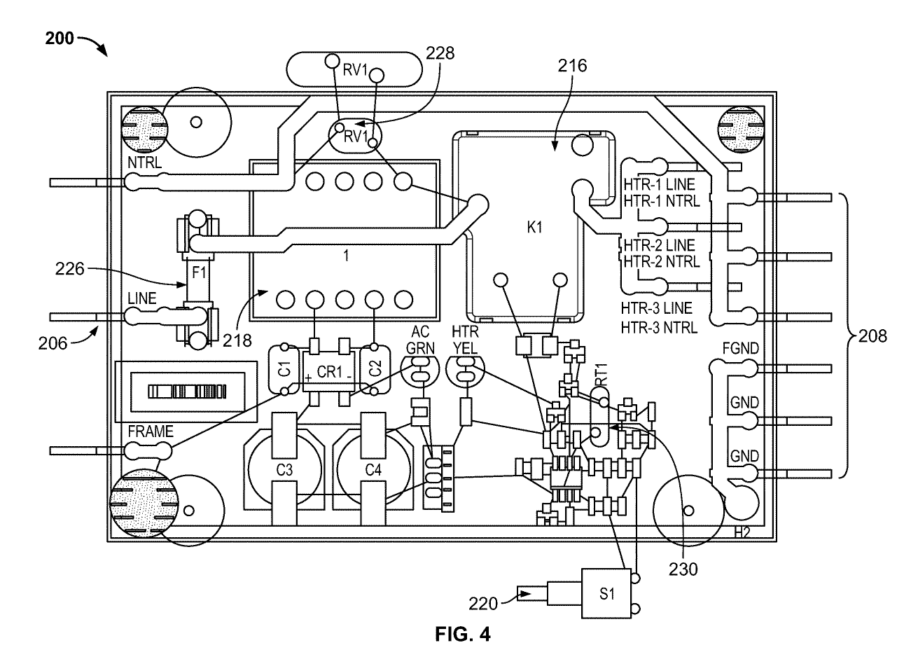

FIG. 3 illustrates an example controller 200 for a battery heater according to another example embodiment of the present disclosure. The controller 200 is similar to the controller 104 of FIG. 1, and may be used in any suitable cabinet, including the cabinet 100 of FIG. 1. FIG. 3 is a top view of a physical layout of the controller 200 mounted on a PCB.

The controller 200 includes three input terminals 206 (e.g., line, neutral and ground for a single phase source), and three sets of AC output terminals 208 for powering three different battery heaters. The input terminals 206 receive a 120 VAC input from an upstream AC power source, and the output terminals 208 selectively provide 120 VAC output power to battery heater(s).

The controller 200 includes a thermistor 214, which provides a sensed ambient temperature to an electronic relay 216. The electronic relay 216 is a 24V VDC control electronic relay. The electronic relay 216 controls a 120 VAC output (e.g., between the input terminals 206 and the output terminals 208), based on the ambient temperature sensed by the thermistor 214.

As shown in FIG. 3, the controller 200 includes a 120 VAC to 24 VAC transformer 218. The 24 VAC is then rectified to 24 VDC to power the electronic relay 216, etc. Other embodiments may include other suitable voltages.

The controller 200 includes visual indicators 222. The visual indicators 222 of FIG. 3 are status display LEDs. For example, one of the visual indicators (PWR ON) indicates when AC power is present at the input terminals 206. Another visual indicator (HTR ON) indicates that AC power is being provided to battery heater(s) at the output terminals 208 (and/or that the test button has been pressed and the controller 200 is capable of providing AC power at the output terminals), as explained above.

In the example of FIG. 3, the controller 200 also includes a cylindrical input fuse and fuse holder 226 for interrupting power/current in the event of an overcurrent condition in the controller 200, and an AC input surge protective device (SPD) 228 to protect from power surges at the input terminals 206.

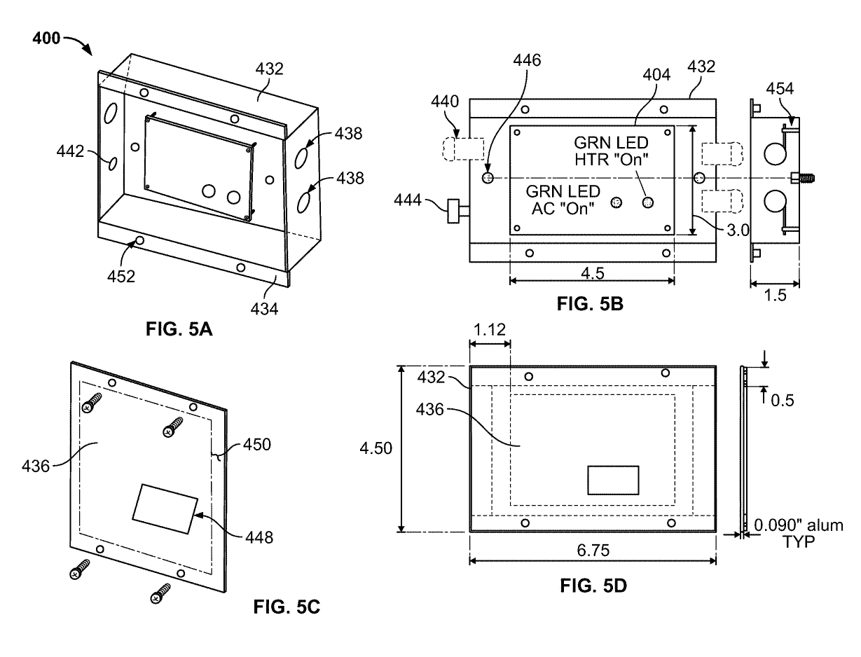

FIG. 4 illustrates a wiring layout of the PCB of the controller 200 of FIG. 3. As shown in FIG. 4, the controller includes a test button 220. The test button 220 may be used by service personnel to test the operation of the controller 200. For example, pressing test button 220 may activate one or more of the visual indicators 222 if the controller 200 is operating properly.

The controller 200 also includes a thermistor temperature control 230. The thermistor temperature control 230 may include a potentiometer, etc. that allows a user to adjust the temperature threshold of the thermistor 214 to determine at what temperatures the battery heater will be used to warm the batteries. For example, the thermistor temperature control 230 may adjust a resistance value in series with the thermistor 214 such that an output signal from the thermistor will not trigger the controller 200 to turn on the battery heaters until a different temperature threshold is reached by the thermistor.

FIGS. 5A and 5B illustrate, respectively, perspective and front views of an example enclosure 400 for the battery heater controllers described herein. As shown in FIGS. 5A and 5B, the example enclosure 400 includes a rear bracket 432 having four side walls. The enclosure 400 includes top and bottom flanges 434 for wall mounting. The side walls include multiple cable grip openings 438 for battery heater cables, a cable grip opening 440 for an AC input, an opening 442 for the test switch 444, etc. The enclosure 400 includes mounting openings 446 for mounting the enclosure to a wall of the cabinet. A battery heater controller 404 may be mounted to studs 454 that provide a standoff distance from the back of the rear bracket 432.

FIGS. 5C and 5D illustrate, respectively an example cover plate 436 used to enclose the PCB of the controller 404 in the enclosure 400. The cover plate 436 may be coupled to the rear bracket 432 at coupling openings 452. The cover plate 436 includes a cutout window 448 for allowing a technician to view status LEDs. A clear laminate label may be placed over the cutout window 448 to seal the interior of the enclosure 400 while allowing for the technician to view the status LEDs. A gasket 450 may be used around the perimeter of the plate 436 to seal the controller inside the enclosure.

Example dimensions are provided in inches in FIGS. 5A-5D for purposes of illustration only, and other embodiments may use any other suitable dimensions. Additionally, although FIG. 5 illustrates the enclosure 400 as including specific walls, brackets, flanges, grip openings, etc., it should be understood that other suitable enclosures may be employed for housing one or more components of the battery heater controllers described herein without departing from the teachings of the present disclosure.

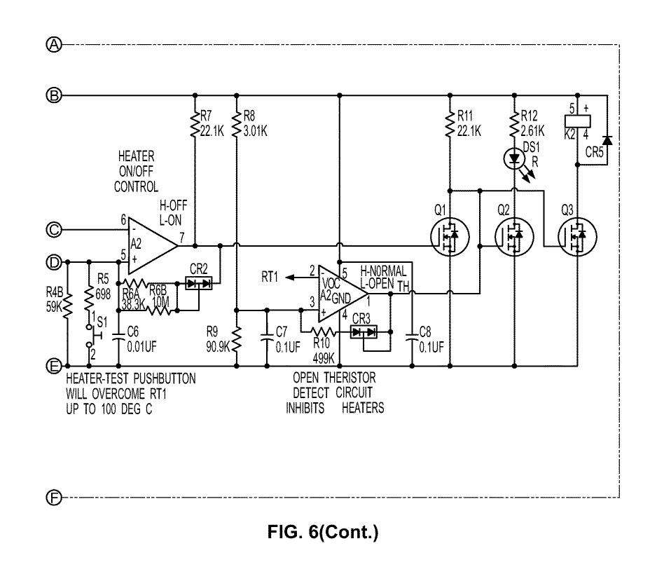

FIG. 6 is an example schematic of a circuit layout of a battery heater controller 500. The controller 500 includes input terminals (MP1, MP2, MP3) for receiving a 120 VAC input voltage. The controller also includes a output terminals (MP4, MP5) for providing an AC output voltage to a battery heater (HEATER #1) and other output terminals (MP6, MP7) for providing an AC output voltage to another battery heater (HEATER #2).

The controller 500 also has an AC to DC converter that includes transformer T1 and rectifier CR1. Additionally, the controller 500 includes a temperature sensor (ON-BOARD NTC AMBIENT SENSOR) for sensing an ambient temperature. The temperature sensor is coupled to a control relay (HEATER ON/OFF CONTROL) for controlling AC current provided to the battery heaters at the output terminals, as explained herein.

Example components are included for purpose of illustration only. Other embodiments may include any other suitable component types.

In another aspect, a method of controlling a battery heater to warm a battery is disclosed. The battery heater is adjacent the battery in a cabinet. The method includes receiving an AC input voltage at an AC input terminal, sensing an ambient temperature via a DC temperature sensor, and switching a DC powered relay coupled between the AC input terminal and the battery heater based on the sensed ambient temperature to control AC power provided to the battery heater.

This example method may be performed by any suitable controller, including but not limited to the example controllers described herein.

Any of the example embodiments and aspects disclosed herein may be used in any suitable combination with any other example embodiments and aspects disclosed herein without departing from the scope of the present disclosure. For example, battery heater controllers described herein may be used in other cabinets, cabinets described herein may include other battery heater controllers, etc. without departing from the scope of the present disclosure.

Example embodiments and aspects of the present disclosure may provide any of the following advantages: lower cost than AC in-line devices or microprocessor DC based relay controllers, simpler design with fewer components than an AC type wired design, simpler DC components, smaller footprint (e.g., saves space in the cabinet), easier maintenance (e.g., less time for an electrician to perform troubleshooting and repair as the technician can instead simply replace a PCB, etc.), lower repair costs, higher temperature accuracy, shorter component lead-time, lower orderable component count, reduced need for multiple AC wires and splices, reduced discrete AC panel mounted devices (e.g., because multiple devices may be placed on a PCB), longer product cycle life using DC controls, etc.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A battery heater controller comprising:
an input terminal for receiving an AC input voltage;
an output terminal for providing an AC output voltage to a battery heater;
a thermistor for sensing an ambient temperature; and
an electronic relay coupled between the AC input and the AC output to selectively interrupt the AC output voltage provided to the battery heater based on the ambient temperature sensed by the thermistor.

2. The battery heater controller of claim 1, further comprising an AC to DC converter coupled between the input terminal, the thermistor and the electronic relay to provide a DC voltage to the thermistor and the electronic relay.

3. The battery heater controller of claim 2, wherein the AC to DC converter includes a transformer and a rectifier.

4. The battery heater controller of claim 3, wherein the transformer includes a 120 VAC to 24 VAC transformer and the rectifier includes a 24 VAC to 24 VDC rectifier.

5. The battery heater controller of claim 1, further comprising a visual indicator to indicate operation of the controller when the controller is providing an AC output voltage to the battery heater.

6. The battery heater controller of claim 5, further comprising a test button coupled to the visual indicator to activate the visual indicator when the test button is pressed and the controller is capable of providing the AC output voltage to the battery heater.

7. The battery heater controller of claim 1, further comprising a printed circuit board, wherein the input terminal, the output terminal, the thermistor and the electronic relay are mounted to the printed circuit board.

8. The battery heater controller of claim 1, wherein the thermistor includes a negative temperature coefficient thermistor.

9. (canceled)

10. The battery controller of claim 1, wherein the AC input voltage is approximately 120VAC and the AC output voltage is approximately 120 VAC.

11. The battery heater controller of claim 1, wherein the battery heater includes at least one of a heater plate, a space heating element, a resistance wire heater and a graphite silkscreen heater.

12. The battery heater controller of claim 1, wherein the controller does not include a microprocessor.

13. The battery heater controller of claim 1, further comprising an enclosure, wherein the thermistor and electronic relay are positioned within an interior space defined by the enclosure.

14. The battery heater controller of claim 13, wherein the test button is accessible without opening the enclosure.

15. An infrastructure cabinet comprising the battery heater controller of claim 1, the cabinet further comprising a battery and a battery heater adjacent the battery, wherein the battery heater is coupled to the AC output of the controller.

16. The infrastructure cabinet of claim 15, wherein the infrastructure cabinet is not a climate controlled cabinet.

17. The infrastructure cabinet of claim 15, wherein the infrastructure cabinet includes an outside plant telecommunication cabinet.

18. A battery heater system including:
a battery;
a battery heater adjacent the battery to warm the battery; and
a controller having an input terminal, an output terminal coupled to the battery heater, a temperature sensor, and an electronic relay coupled between the input terminal and the output terminal to selectively interrupt AC power provided to the battery heater at the output terminal based on an ambient temperature sensed by the temperature sensor.

19. The system of claim 18, wherein the battery is a lead-acid battery.

20. The system of claim 19, wherein the battery is a valve-regulated lead-acid battery.

21. A method of controlling a battery heater to warm a battery, the battery heater adjacent the battery in a cabinet, the method comprising:
receiving an AC input voltage at an input terminal;
sensing an ambient temperature via a temperature sensor; and
switching an electronic relay coupled between the input terminal and the battery heater based on the sensed ambient temperature to selectively interrupt AC power provided to the battery heater.
